(19) United States
(12) Patent Application Publication
(10) Pub. No.: US 2003/0193974 A1
(43) Pub. Date: Oct. 16, 2003

(54) Tunable multi-wavelength laser device

(76) Inventors: Robert Frankel, Rochester, NY (US); John Hoose, Fairport, NY (US)

Correspondence Address: ROPES & GRAY LLP, ONE INTERNATIONAL PLACE, BOSTON, MA, 02110-2624, US

(21) Appl. No.: 10/212,844

(22) Filed: Aug. 5, 2002

Related U.S. Application Data
(60) Provisional application No. 60/373,049, filed on Apr. 16, 2002.

(51) Int. Cl. H01S 3/10

(52) U.S. Cl. 372/20

(57) ABSTRACT

A tunable external cavity multi-wavelength laser device employs a stationary, electrically and/or thermally tunable solid state immersion grating as a wavelength-selective element. The laser device significantly reduces the number of lasers required to span the ITU grid in DWDM applications.

### CROSS-REFERENCE TO OTHER PATENT APPLICATIONS

This application claims the benefit of U.S. provisional Application No. 60/373,049, filed Apr. 16, 2002, the subject matter of which is incorporated herein by reference in its entirety.

### FIELD OF THE INVENTION

The invention is directed to a tunable multi-wavelength laser device, and more particular to a tunable multi-wavelength laser device using an electrically and/or thermally tunable solid state immersion grating. Employing a tunable grating significantly reduces the number of lasers required to span the ITU grid in DWDM applications.

### BACKGROUND OF THE INVENTION

Future optical communications systems will migrate to larger numbers of different wavelength channels placed on the ITU grid at 25, 50 and 100 GHz frequency spacing. In addition, along with the increasing number of channels, future optical networks will require lasers for each channel that must be tunable to fully utilize wavelength routable services. Ideally technology will improve to the point were a broadly tunable laser over the entire C & L bands (1530-1620 nm) would cost less than presently available fixed wavelength, or narrowly tunable, distributed feedback (DFB) lasers. At present, commercially available lasers that can be tuned over a broad wavelength range rely on either moving parts or complex semiconductor processing.

Examples of lasers requiring moving parts are commercially available. Among those are external cavity lasers in the Littman-Metcalfe configuration and tunable vertical cavity lasers employing Micro-Electro-Mechanical-System (MEMS) flexible membrane mirrors. Other conventional tunable lasers use a sampled Bragg grating tunable semiconductor laser of a rather complex design composed of multiple sections requiring different, several precisely controlled drive currents in operation, and multiple complex patterning steps during fabrication.

In particular optical communication applications could benefit from a compact, inexpensive tunable laser source to reduce the number of lasers to be provisioned for DWDM systems. Conventional tunable multi-laser external cavity laser systems require a separate diode laser or laser element in a diode laser array for each lasing wavelength, or mechanical rotation of a grating for tuning the lasing wavelength of each laser.

It is therefore desirable to provide a laser system without moving parts and a reduced number of components that can be tuned over at least a portion of the ITU grid and produced using standard semiconductor processing tools.

### SUMMARY OF THE INVENTION

The device and system described herein are directed to a free space multi-wavelength laser employing an electrically and/or thermally tunable immersion grating.

According to one aspect of the invention, a wavelength-tunable multi-wavelength light source includes a plurality of optical emitters, wherein each emitter is capable of optical emission over a corresponding first wavelength range; a first mirror device and a second mirror device forming an external cavity, wherein the plurality of optical emitters is located between the first mirror device and the second mirror device; a wavelength-selective element in form of a stationary tunable immersion grating located between the first mirror device and first facets of the plurality of optical emitters facing the wavelength-selective element, the wavelength-selective element wavelength-selectively diffracting the optical emission emitted by an emitter for wavelength-selective return to the emitter; and tuning means connected to the wavelength-selective element for changing a physical property of the wavelength-selective element. A change in the physical property of the wavelength-selective element changes a wavelength of the returned optical emission within the corresponding first wavelength range of the optical emitter.

According to another aspect of the invention, a wavelength-tunable multi-wavelength laser light source includes a plurality of optical emitters, wherein each optical emitter is capable of optical emission over a corresponding wavelength range; a wavelength-selective element in form of a stationary tunable immersion grating wavelength-selectively diffracting the optical emission emitted by an emitter and returning the diffracted optical emission to the emitter; an external cavity to provide a round-trip gain; and tuning means connected to the wavelength-selective element for changing a physical property of the wavelength-selective element. A change in a physical property of the wavelength-selective element changes a wavelength of the diffracted optical emission within the corresponding wavelength range of the optical emitter.

Embodiments of the invention may include one or more of the following features. The physical property can be a refractive index of the immersion grating material. The tuning means may include charge injection elements disposed on said wavelength-selective element and/or heating/cooling elements connected to or disposed on said wavelength-selective element. The optical emitters can be semiconductor laser elements that may be integrated on a single semiconductor chip, wherein the second mirror device may include second facets of the optical emitters.

The stationary tunable immersion grating can be made of a semiconductor material and said tuning means can include electrical charge injection regions formed thereon to change the refractive index of the semiconductor material. Alternatively, the stationary tunable immersion grating can include an electrooptic material and said tuning means include electrical contacts disposed thereon to change the refractive index of the electrooptic material. The immersion grating can be in form of a prism and the grating element can be integral with the prism or formed separately on a face of said prism. In addition, an etalon can be placed between the first mirror and the diffractive element. The etalon can be wavelength-tunable or can have fixed transmission bands corresponding to the ITU wavelength grid.

The wavelength-selective element or immersion grating can be made of a material selected from the group consisting of group IV, III-V and group II-VI materials and lithium niobate.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a conventional multi-emitter external cavity laser in Littman-Metcalf configuration;

FIG. 2 shows schematically a multi-emitter external cavity laser with a tunable immersion grating in Littman-Metcalf configuration;

FIG. 2A shows schematically a multi-emitter external cavity laser with a tunable immersion grating in Littrow configuration;

FIG. 3 is a perspective view of an electric-field tunable semiconductor grating-prism device; and

FIG. 4 shows schematically channel-tuning with a reduced number of laser elements.

### DETAILED DESCRIPTION OF CERTAIN ILLUSTRATED EMBODIMENTS

The systems described herein are directed to multi-wavelength light sources and more particularly to an external cavity grating-tuned laser light source without moving parts.

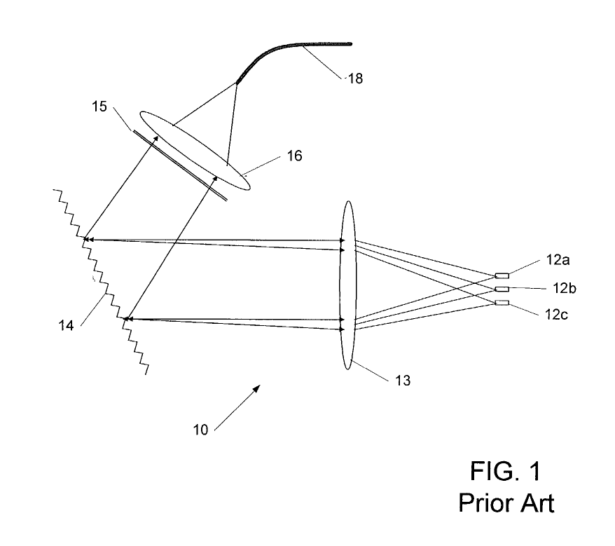

FIG. 1 shows schematically a conventional multi-wavelength external cavity laser 10 in Littrow geometry (angle of incidence identical to angle of diffraction). The external cavity laser 10 includes a plurality of laser cavities bounded by a partially reflecting output coupling mirror 15 and the distal facets of individual laser diodes 12a, 12b, 12c. Laser diodes may be either surface emitting or edge emitting laser diodes. The individual laser diodes 12a, 12b, 12c can also be implemented as laser diode elements arranged on a common substrate or carrier. An intra-cavity frequency dispersive grating 14 and the cavity length between the mirror 15 and the facets of laser diodes l 2a, 12b, 12c define the lasing wavelengths. Laser light emitted by the proximal facets of laser diodes 12a, 12b, 12c is collimated by lens 13 before impinging on the grating 14. Each laser diode 12a, 12b, 12c is positioned to receive a different diffracted wavelength from the dispersive grating 14 and hence lases at a different wavelength. The lasers can be separately addressable and can be arranged in a linear or two-dimensional array. The coaxial multi-wavelength output beam passing through the output coupling mirror 15 is focused by a lens 16 on a fiber 18 for transmission through the fiber.

The wavelength of the lasers/laser elements 12a, 12b, 12c can be tuned by changing the diffraction angle of the grating 14, for example, as mentioned above, by rotating the grating (not shown). However, this process is slow and expensive to implement.

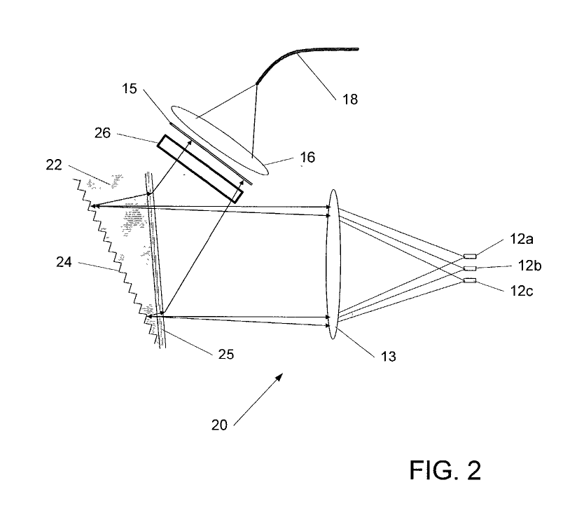

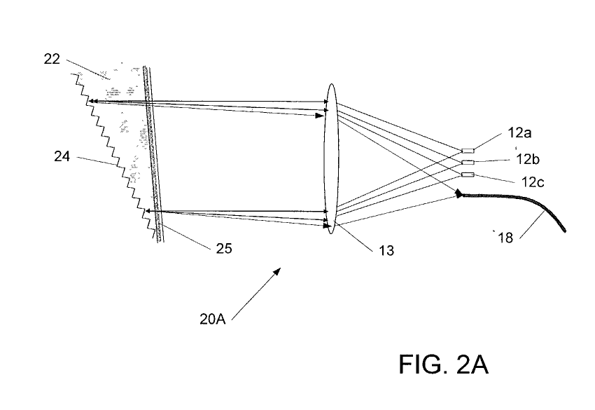

FIG. 2 shows an exemplary embodiment of a multi-wavelength system 20 in Littman-Metcalf configuration. The standard grating 14 in the prior art system 10 is herein replaced by an immersion grating 22 made, for example, of a semiconductor or another material having a tunable refractive index. An immersion grating 22 is essentially a prism, with a grating structure 24 formed in or attached to a face of the prism. The diffraction angle of a grating can be altered by changing the index of refraction of the immersion grating 22. A change in the refractive index changes the effective wavelength of the light in the grating 22 and hence the diffraction angle. Exemplary immersion gratings can be made of Silicon (Si), Gallium Arsenide (GaAs), Indium Phosphide (InP), Gallium Nitride (GaN), or ternary or quaternary materials like Indium Gallium Arsenide Phosphide (IinGaAsP). Other semiconductors and materials, such as lithium niobate and plastics, that have an index of refraction in the infrared that with a significant temperature or electrical or carrier or voltage dependence may also be used. For example the change in refractive index with temperature (dn/dT) of Si is about 0.0002/° C. while that of InAsGsP is about 0.002/° C. A grating-prism combination could be fabricated in silicon which has an index of refraction of n_{Si}=3.48. A refractive index change of (1-5)×10⁻² can be easily achieved with thermal tuning or charge injection. For example, this magnitude of index change is readily achievable with a temperature change of ±20° C., or carrier injection with a carrier concentration of 10¹⁷/cm³. A 100 μm beam displacement is more than sufficient to switch light between the laser elements with greater than 30 dB contrast. The input face 25 of the grating 22 can be anti-reflection coated.

As indicated in FIG. 2, an additional intra-cavity etalon 26 can be inserted in the optical path to narrow the linewidth and stabilize the emission wavelength. The etalon 26 can be designed for a fixed wavelength spacing, corresponding for example to the ITU grid, or can be tuned synchronously with the grating structure 24 for continuous wavelength tuning.

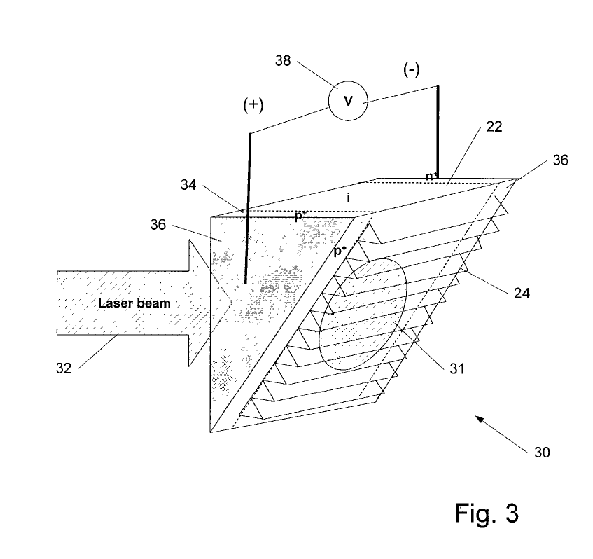

FIG. 2A shows another exemplary embodiment of a multi-wavelength system 20A in Littrow configuration, which also includes the immersion grating 22. As known in the art, in Littrow configuration the grating structure 24 of the immersion grating 22 functions as one of the external mirrors (mirror 15 in FIG. 2) of the external laser cavity. FIG. 3 shows schematically a semiconductor grating structure 30 used with the immersion grating 22, wherein a refractive index change can be induced by charge injection into the grating and prism. The exemplary grating structure 30 is advantageously formed on an insulating or semi-insulating substrate, for example i-Si, having surrounding p⁺- and n⁺-doped stripe regions 34, 35 formed thereon, which can be electrically contacted by contact pads 36, 37 (not visible in FIG. 3) connected to a suitable power supply or controller 38. The p⁺- and n⁺-doped regions 34, 35 are electrically separated. By applying an electric potential to contact pads 36, 37, as indicated by the (+) and (−) signs, the carriers can be made to across the grating changing the carrier concentration in the intrinsic substrate material. Also indicated are an incident laser beam 32 and the laser footprint 31 formed by the laser beam 32 on the grating surface 24.

Alternatively, cooling and/or heating devices, for example thermoelectric coolers and/or resistance heaters or absorbing surfaces for laser heating, can be provided to temperature-tune the refractive index of immersion grating 22.

Soref and Bennett (IEEE Journal of Quantum Electronics, Vol. QE-23, No. 1, January 1987) reported that the change in the refractive index An for n-type silicon can be described by the equation:

$$Δ n = - ( {ⅇ}^{2} {λ}^{2} / 8 {π}^{2} {c}^{2} {ϵ}_{0} n ) [ Δ {N}_{c} / {m}_{cc}^{* 2} + Δ {N}_{h} / {m}_{ch}^{* 2} ] \qquad ( 1 )$$

wherein e is the electronic charge, ε₀ is the permittivity of free space, n is the refractive index of unperturbed intrinsic Si, m_{ce} is the electron effective mass, m_{ch} is the hole effective mass, and ΔNₑ and ΔNₕ represent the changes in electron and hole carrier concentration, respectively. A change in the refractive index can be achieved by carrier injection/depletion in the intrinsic region of the silicon immersion grating 22.

The speed of the device is limited by the device capacitance and carrier diffusion times between the n⁺ and p⁺ regions for charge injection devices and by the thermal diffusivity for temperature tuning. This would allow silicon devices to operate in the KHz range and GaAs and GaInAsP devices to operate well above 100 KHz. It should be noted that with proper design the grating 30 and the external cavity multi-wavelength laser 20 employing the grating 30 could operate in a polarization independent manner. Polarization independent operation is a significant benefit in many optical network applications, although lasers operate with one polarization.

Eq. (2) below shows the change in the diffraction angle β as a function of the refractive index η of the grating material can be computed from the grating equation:

mλ/ηd=sin α+sin β (2),

wherein λ is the vacuum wavelength of the light, m is diffracted order number, d is the spacing between adjacent grating grooves, a is the angle of incidence of the incoming light and β the angle of the diffracted light with respect to the grating surface normal.

A change in the index η of the grating region, e.g. by charge injection or temperature tuning, changes the resonant wavelength of the cavity defined by the output coupling mirror 15 and the distal facets of the laser diodes 12a, 12b, 12c. Since the external cavity lasing wavelengths of all laser diodes vary in unison, the diode array can be tuned over an entire communication band with many fewer diodes than the number of channels in the communication system, which saves materials and assembly cost.

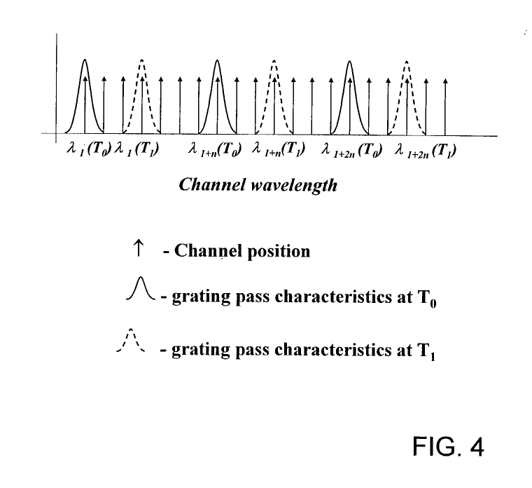

FIG. 4 illustrates schematically a distribution of laser output wavelengths λ₁, λ₁₊ₙ, λ₁₊₂ₙ, . . . emitted by the exemplary laser diodes 12a, 12b, 12c at two different grating region temperatures T₀ and T₁ for a temperature-tuned grating region. For one refractive index of the grating region, for example at temperature T₀, the exemplary laser diodes can be configured in the system to lase at every nth communication channel, for example, λ₁, λ₁₊ₙ, λ₁₊₂ₙ, . . . , with n=7 in the example depicted in FIG. 4. However, different values of n may be selected, for example, 2<n<20. In the following example, an electric field E or electric current can be easily substituted for the temperature Tᵢ, as known in the art. At a different temperature T₁ or current or electric field E₁, the changed diffraction angle can then cause the laser diodes to lase at channels displaced by Δn channels, with Δn=1, 2, . . . , n−1, wherein Δn depends of the value of the corresponding temperature and/or electric field/current and the physical parameters of the material selected for the grating. If there are m channels in the communication band of interest, m/Δn laser diodes may provide full band tunablity. For example, due to the smaller temperature/electric field dependence of the refractive index, a Si grating in a compact multi-diode system may require Δn=2 for a system with channel spacing of 50 GHz or Δn=4 for a 25 GHz channel spacing. Conversely, for a grating made of III-V materials, Δn may cover as many as 16 channels in the 1300-1500 nm range for a 50 GHz channel spacing due to the larger dn/dT or dn/dE. Accordingly, the entire C band between 1530 and 1560 nm may be covered using just 5 stripes. Having fewer laser diodes is a significant cost advantage. Fewer laser diodesallow the multiplexer lens to be smaller and less costly and significantly reduce wiring complexity of the packaged device.

The tunable laser should operate in a single longitudinal mode. This can be accomplished by incorporating one or more of the following mode control strategies:

1. The intra-cavity etalon (shown in FIG. 2) may be designed to have a high finesse of 50-100 while the free spectral range of the etalon is designed to be equal to the standard communications channel spacing of 25, 50 or 100 GHz.

2. The longitudinal cavity modes laser can be spaced far enough apart, for example, by making the laser cavity shorter, so that only a single, or at most a few, cavity modes are within the dispersive feedback of the intra-cavity grating.

3. The optical path length of the laser elements may be separately adjusted by current or thermal tuning to be resonant with the required ITU grid channel central wavelength.

4. A wavelength locker can be used, as described for example in commonly assigned U.S. patent application Ser. No. 10/118,640, which is incorporated herein by reference.

The external cavity tunable laser can advantageously use Fabry-Perot or VCEL lasers which are less expensive to manufacture than DFB or DBR lasers. Moreover, Fabry-Perot lasers are capable of operating at higher power than DFB or DBR lasers. If all laser diodes are powered simultaneously, a tunable comb of output wavelengths will be emitted from the laser. The simultaneous tunability of the entire comb allows new types of wavelength provisioned services to be built into optical networks. The new type of tunable laser disclosed herein has the potential to provide optical networks with a simple tunable source for single and/or multiple wavelengths for wavelength-agile optical networks.

While the invention has been disclosed in connection with the preferred embodiments shown and described in detail, various modifications and improvements thereon will become readily apparent to those skilled in the art. For example, the laser diodes can be individual laser diodes or multi-stripe laser diodes arranged on a common substrate. Accordingly, the spirit and scope of the present invention is to be limited only by the following claims.

We claim:

1. Wavelength-tunable multi-wavelength light source comprising
a plurality of optical emitters, each emitter capable of optical emission over a corresponding first wavelength range;
a first mirror device and a second mirror device forming an external cavity, with said plurality of optical emitters located between said first mirror device and said second mirror device;
a wavelength-selective element in form of a stationary tunable immersion grating located between the first mirror device and first facets of said plurality of optical emitters facing said wavelength-selective element, said wavelength-selective element wavelength-selectively diffracting the optical emission emitted by an emitter for wavelength-selective return to said emitter; and
tuning means connected to said wavelength-selective element for changing a physical property of said wavelength-selective element,
wherein a change in the physical property of said wavelength-selective element changes a wavelength of said returned optical emission within said corresponding first wavelength range of the optical emitter.

2. The light source of claim 1, wherein said tuning means comprise charge injection elements disposed on said wavelength-selective element.

3. The light source of claim 1, wherein said tuning means comprise heating/cooling elements connected to or disposed on said wavelength-selective element.

4. The light source of claim 1, wherein the optical emitters are semiconductor laser diodes.

5. The light source of claim 1, wherein the optical emitters are semiconductor laser elements integrated on a single semiconductor chip.

6. The light source of claim 1, wherein said second mirror device comprises second facets of said plurality of optical emitters.

7. The light source of claim 1, wherein said physical property is a refractive index.

8. The light source of claim 7, wherein said stationary tunable immersion grating comprises a semiconductor material and said tuning means include electrical charge injection regions formed thereon to change the refractive index of the semiconductor material.

9. The light source of claim 7, wherein said stationary tunable immersion grating comprises an electrooptic material and said tuning means include electrical contacts disposed thereon to change the refractive index of the electrooptic material.

10. The light source of claim 1, wherein said immersion grating comprises a prism and a separately formed grating element disposed on a face of said prism.

11. The light source of claim 1, further comprising an etalon disposed between the first mirror and the diffractive element.

12. The light source of claim 1, wherein a combined optical emission from the plurality of optical emitters spans a second wavelength range substantially overlapping a transmission band for optical communications.

13. The light source of claim 1, wherein said first wavelength range is less than a center-to-center spacing of adjacent wavelength from different optical emitters.

14. The light source of claim 1, wherein said wavelength-selective element comprises a material selected from the group consisting of group IV, III-V and group II-VI materials and lithium niobate.

15. The light source of claim 11, wherein said etalon is wavelength-tunable.

16. The light source of claim 11, wherein said etalon has fixed transmission bands corresponding to the ITU wavelength grid.

17. Wavelength-tunable multi-wavelength laser light source comprising
a plurality of optical emitters, each optical emitter capable of optical emission over a corresponding wavelength range;
a wavelength-selective element in form of a stationary tunable immersion grating wavelength-selectively diffracting the optical emission emitted by an emitter and returning the diffracted optical emission to said emitter;
an external cavity to provide a round-trip gain; and
tuning means connected to said wavelength-selective element for changing a physical property of said wavelength-selective element,
wherein a change in a physical property of said wavelength-selective element changes a wavelength of said diffracted optical emission within said corresponding wavelength range of the optical emitter.

18. The laser light source of claim 17, wherein said physical property is a refractive index.

19. The laser light source of claim 18, wherein said stationary tunable immersion grating comprises a semiconductor material and said tuning means include electrical contacts disposed thereon to change the refractive index of the semiconductor material.

20. The laser light source of claim 18, wherein said stationary tunable immersion grating comprises a heating device for changing the refractive index of the wavelength-selective element.
